(19) United States
(12) Patent Application Publication
(10) Pub. No.: US 2003/0177091 A1
(43) Pub. Date: Sep. 18, 2003

(54) Emerging market banking system

(76) Inventor: Renan C. Paglin, Ozone Park, NY (US)

Correspondence Address: Mr. Walter J. Tencza Jr., Suite 3, 10 Station Place, Metuchen, NJ, 08840, US

(21) Appl. No.: 10/095,998

(22) Filed: Mar. 12, 2002

(51) Int. Cl. G06F 17/60

(52) U.S. Cl. 705/42

(57) ABSTRACT

A banking system for emerging market countries which includes a central flow control apparatus or system, is disclosed. The central flow control apparatus may include an interface layer, an applications layer, and a presentation layer. The banking system may be comprised of a first bank account directly owned by a first emerging market bank and a second bank account which is owned by a trust (or other special purpose legal entity), wherein the emerging market bank is the beneficiary of the trust. The first bank account and the second bank account are bank accounts of a first international correspondent bank. The first bank account would typically be an on shore account which can be controlled by actions of a first emerging market government of the first emerging market country. The second bank account would typically be an off shore account which can not be controlled by actions of the first emerging market government of the first emerging market country.

### FIELD OF THE INVENTION

This invention relates to international banking systems between banks chartered in emerging market countries and international correspondent banks.

### BACKGROUND OF THE INVENTION

Emerging market countries manage their financial payments with the rest of the world through a system of international correspondent banks. Other countries that trade with emerging market countries usually do not accept that country's local currency for trade payments. Acceptable payments are largely limited to the three major currencies (i.e., U.S. dollars, Japanese Yen or Euros). Accordingly, an emerging market banking system has to deal with foreign banks to manage its supply of foreign currencies used for transactions with the rest of the world. Foreign banks which hold deposits for the emerging market banks, and which transact on their behalf are called international correspondent banks. For example, the payment transactions which could give rise to the foreign exchange (or “FX” for short) to be used as collateral for the securitization financing include those that involve non-documentary trade payments, other payments for export of invisibles and services, remittances of overseas workers, foreign direct investments, and dividend and interest income of residents in the emerging market country. The payment transactions to be used as collateral assets for the financial securitization originate from international correspondent banks, which perform payment and collection services for the emerging market. Together these international banks comprise the international correspondent banking system. The major international correspondent banks are headquartered in the Group of 7 (as defined by the International Monetary Fund) countries. The foreign-currency accounts with international correspondent banks used by emerging market banks to manage their trade transactions are called nostro accounts.

### SUMMARY OF THE INVENTION

It is an object of the present invention in one or more embodiments to insert an electronic process between an emerging market's banking system and the rest of the world. This electronic process is enabled by a networked computer system, which is connected to the world's international correspondent banks through a data telecommunications network. The present invention provides a central flow control apparatus or system which enforces certain contracts with bond investors entered into by certain participating banks in the emerging market country (n emerging market bank) so that its government, monetary authority or central bank can access international financing at favorable terms. This type of financing is commonly referred to as a future-flows financial securitization. The central flow control apparatus or system is an electronic technology that makes possible certain financial transactions and can therefore be classified as a financial technology.

The present invention in one or more embodiments discloses a banking system comprising a first bank account directly owned by a first emerging market bank chartered under the laws of a first emerging market country and a second bank account which is owned by a trust or other similar special purpose legal entity, wherein the first emerging market bank is the beneficiary of the trust or other similar special purpose legal entity. The first bank account and the second bank account are bank accounts at a first international correspondent bank. The first bank account would typically be an on shore account which can be controlled by actions of a first emerging market government of the first emerging market country. The second bank account would typically be an off shore account which can not be controlled by actions of the first emerging market government of the first emerging market country.

The banking system may be further comprised of a central flow control apparatus which can administer the first and second bank accounts. The central flow control apparatus may be comprised of an interface layer, an applications layer, and a presentation layer. Each of these layers may be comprised of one or more processors, computers, or computer processors for performing various functions. For example the interface layer may be comprised of interface processors each of which interfaces with an electronic banking system of the first international correspondent bank. The applications layer may be comprised of applications processors each of which receives an interface object from an interface processor. The applications layer may also be comprised of applications processors, which interface with transaction data information residing in a database processor. The presentation layer may be comprised of presentation processors, each of which also receives an interface object from an interface processor.

The interface object may be comprised of a first code referring to the first international correspondent bank, a second code referring to the first emerging market bank, and a third code referring to the second bank account. Each of the applications processors may store all activities which access the first or the second bank account in a database. Each of the applications processors may route FX funds available in the second bank account according to a decision criteria specified in a FX purchase agreement between an emerging market central bank and the trust or special purpose entity owned by the first emerging market bank. Each of the presentation processor may report aggregate activity for the first and second bank accounts. Each of the presentation processors may report aggregate monthly cash flow coverage statistics concerning the first and second bank accounts to the emerging market central bank of the emerging market country or to a credit rating agency. These reporting functions can occur electronically in any known manner, such as through a private data network, by wireless, by fiber optics or by any other electronic communication method.

The present invention in one or more embodiments also discloses a method comprising the steps of setting up a first bank account directly owned by a first emerging market bank chartered in a first emerging market country and setting up a second bank account which is owned by a trust or a similar special purpose entity wherein the first emerging market bank is the beneficiary of the trust or special purpose legal entity. The first bank account and the second bank account are typically bank accounts at a first international correspondent bank. The first bank account is typically an onshore account which can be directly or indirectly controlled by actions of a first emerging market bank or the government of the first emerging market country, and typically the second bank account is an off shore account which can not be controlled by actions of the first emerging market bank or the government of the first emerging market country. The first and second bank accounts can be administered through a central flow control apparatus.

### BRIEF DESCRIPTION OF THE DRAWINGS

FIG. 1 shows a diagram of a prior art banking system between an emerging market bank and a plurality of international correspondent banks;

FIG. 2 shows a diagram of an overview of a banking system in accordance with a first embodiment of the present invention;

FIG. 3 shows a diagram of a detailed embodiment of a banking system in accordance with a second embodiment of the present invention;

FIG. 4 shows a diagram of the flow of monetary funds under normal circumstances in a banking system in accordance with the first or second embodiments of the present invention;

FIG. 5 shows a diagram of the flow of monetary funds in a foreign exchange control scenario in a banking system in accordance with the first or second embodiments of the present invention; and

FIGS. 6A and 6B shows a flow chart of a method for handling daily monetary funds in accordance with the first or second embodiments of the present invention.

### DETAILED DESCRIPTION OF THE DRAWINGS

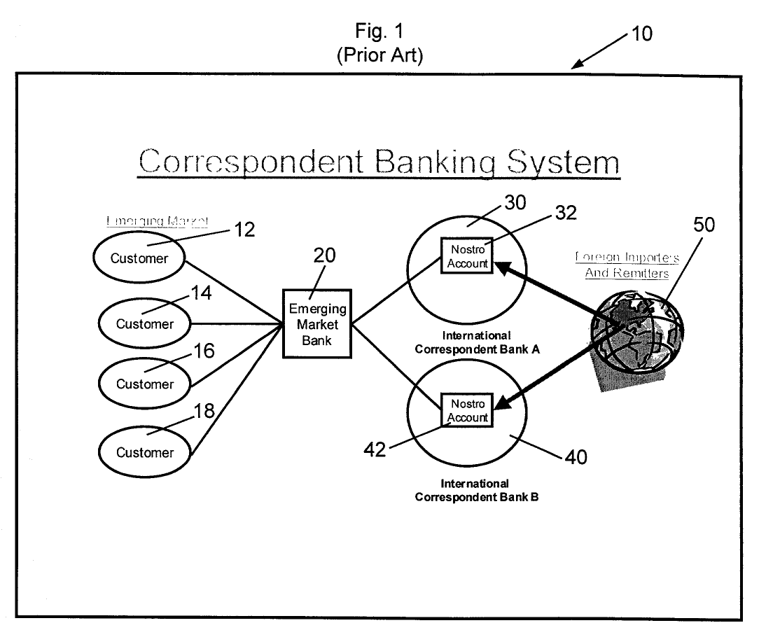

FIG. 1 shows a diagram of a prior art banking system 10 between an emerging market bank 20 and international correspondent banks 30 and 40. The emerging market bank 20 may receive funds for customers 12, 14, 16, and 18, from foreign (i.e., foreign to the emerging market country) remitters of FX who reside outside the emerging market country such as 50. The customers of the emerging market bank 20 may be local customers who reside in the emerging market country in which the emerging market bank 20 is chartered. The international correspondent banks 30 and 40 operate in various countries which may include the country in which the emerging market bank 20 is chartered. The emerging market bank 20 may maintain one or more “nostro accounts” in international correspondent bank 30 and 40 such as “nostro account” 32 and 42. As previously described, a “nostro” account is an account of the emerging market bank with an international correspondent bank into which hard currency deposits can be made, for the purpose of managing the emerging market bank's payment and collection transactions with foreign parties who reside outside the emerging market country. A “hard currency” is the currency of one of the major industrial nations such as the United States of America.

In the real world, relationships with only two international correspondent banks, such as the example of banks 30 and 40, would be a small number for most emerging market banks. Large emerging market banks typically have between several dozen to several hundred international correspondent banking relationships.

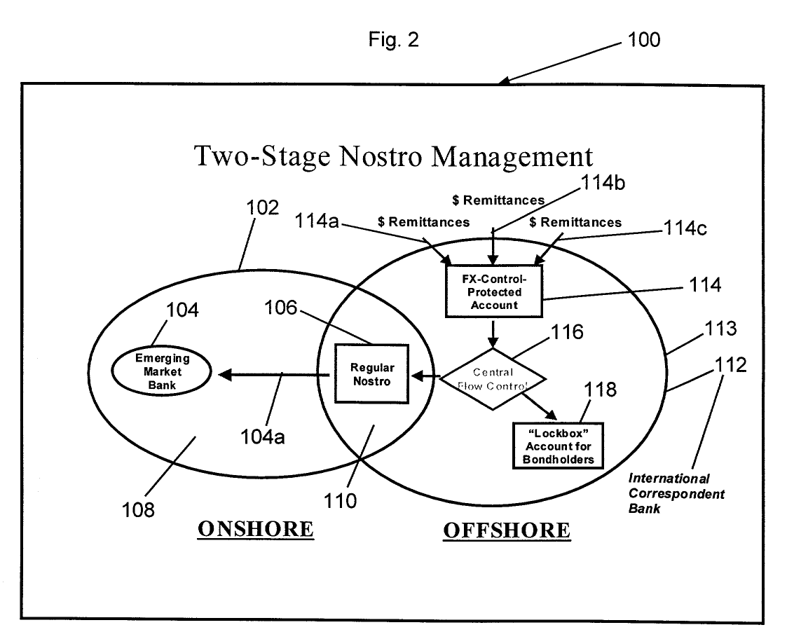

FIG. 2 shows a diagram of an overview of a banking system 100 in accordance with a first embodiment of the present invention. In the banking system 100, in addition to the prior art “nostro” account 106, a FX-control-protected account 114, a central flow control apparatus 116, and a lockbox account for bondholders 118 is also shown. The initials “FX” means “foreign exchange”. The FX control-protected account 114 is an account owned by the trust (or other similar special purpose legal entity) set up to legally own the remittances such as 114a, 114b, and 114c and which emerging market bank 104 is the beneficiary. The area inside ellipse 102 represents an account or a bank that is located in the emerging market country and/or subject to the control of the government of the emerging market country. The emerging market bank 104 and a regular nostro account 106 are shown inside the ellipse 102. As an example, the emerging market bank 104 may be a local bank whose physical and legal headquarters is in the Philippines. The regular nostro account 106 may be a bank account at international correspondent bank 112 (organized outside the emerging market country where emerging market bank 104 resides) which is directly owned by and in the name of the emerging market bank 104. The international correspondent bank 112 will usually be headquartered in a developed country, such as the United States of America or other member country of the “Group of 7”(also known as G7) countries grouped by the International Monetary Fund. The area inside the ellipse 113 represents accounts or apparatus administered by the international correspondent bank 112 but which may be subject to government supervision of a country other than the emerging market country because the international correspondent bank is based in that other country. The FX-control-protected account 114 is shown in ellipse 114, along with the central flow control apparatus 116 and the lockbox account for bondholders 118.

The intersecting area of ellipses 102 and 113, in which is located the regular nostro account 106, represent bank accounts which are administered by the international correspondent bank 112 but which are subject to the direct or indirect control of the government of the emerging market country. The international correspondent bank 112 is capable of receiving remittances from any entity who is not a resident of the emerging market country, in an electronic or computerized manner, or otherwise, via the inputs 114a, 114b, and 114c to the FX-control-protected account 114. The FX-control-protected account 114 may electronically communicate with central flow control apparatus 116 which may electronically communicate with lockbox account for bondholders 118. The regular nostro account 106 may electronically communicate with the central flow apparatus 116. The regular nostro account 106 may also electronically communicate with the emerging market bank 104.

The reference in FIG. 2 to “ONSHORE” refers to the ellipse 102 and to accounts owned by banks or bank branches physically located in the emerging market country and/or subject to the direct or indirect control of the government of the emerging market country. The reference in FIG. 2 to “International Correspondent” bank refers to the contents of ellipse 113.

For an emerging market bank, such as bank 104 in FIG. 2 to participate in the banking system 100, the emerging market bank would establish a trust entity under foreign law. The trust entity need not be formally organized as a trust. It can be organized as another form of entity such as a corporation, for as long as it is formed for a special purpose so that it will be protected from bankruptcy risks. However, for convenience, the term “trust” is used to refer to this entity although the invention should not be limited to legally organized trusts and should work with any form of special purpose entity commonly utilized for financial securitizations. For example, in the previous example, the emerging market bank could establish a trust entity under the law of the Cayman Islands. The FX-control-protected account 114 is an example of an FX account owned by such a trust entity. The emerging market bank would be the beneficiary of the trust and an international correspondent bank, such as bank 112 in FIG. 2, would be the depository bank where the trust would deposit its FX assets.

Through the trust, the emerging market bank 104 can beneficially, rather than directly, own the foreign currencies (foreign to the emerging market country) received from residents of other countries. The transfer of the foreign currency receivables from the emerging market bank 104 to the offshore trust or the FX-control-protected account 114 is based on a true sale under the law of the emerging market country. True sale is required so that the foreign currencies cannot be consolidated with accounts directly owned by the emerging market bank 104 in the event that the emerging market bank 104 becomes insolvent and falls under the jurisdiction of a bankruptcy proceeding.

The trust or FX-control-protected account 114 is organized offshore (outside the jurisdiction of the government of the emerging market country) so that the government of the emerging market country cannot force the trust to surrender its foreign currency assets or to violate any contracts with third parties. Because these offshore trust accounts are structured to be protected from controls imposed by the government of the emerging market country on the convertibility of its local currency into hard currency such as U.S. dollars or the remittance of such hard currency to outside parties, these trusts are referred to in this paper as foreign-exchange control protected (or “FX-control protected”), a description that is derived from the term “foreign-exchange control”, which means a government-declared suspension of convertibility of local currency to foreign currency, which may nor may not accompany a general or selective moratorium on the servicing of foreign debt obligations. The description of FX-control-protected should not be understood to exclusively mean protection from debt standstill.

In general, the offshore trust or FX-control-protected account 114, if validly established under a foreign jurisdiction (i.e., offshore, i.e. in this example in the United States), and the FX-control-protected account such as 114 owned by an offshore trust should protect the foreign currency assets from any form of FX control or capital control imposed by the government of the emerging market country, including but not limited to general or selective moratorium on debt servicing by public or private entities in the emerging market country.

Once the emerging market bank 104 has established an offshore trust account or FX-control-protected account 114 to beneficially own future foreign-currency assets that it would have previously owned directly, each of its nostro accounts, such as nostro account 106, at international correspondent banks, such as at international bank 112 can be bifurcated into two accounts, namely the FX-control-protected account and the original nostro account. In similar fashion, the offshore trust can open a new FX-control-protected account 114 with each of its pre-existing correspondent bank relationships, to operate as a pair together with its regular nostro account 106. The FX-control-protected account 114 will then be enrolled or implemented with the central flow control apparatus 116 which can then enforce contracted cash movements between the FX-control-protected account 114 and the bank's regular nostro account 106 as illustrated in FIG. 2. Through the central flow control apparatus 116, the pair of accounts can be tightly linked so that the accounts 106 and 114 have to a large degree the same convenience of one account for the emerging market bank 104. The central flow control apparatus 116 can also monitor and enforce the contractual cash flows promised by the emerging market banks, such as bank 104 (acting through their offshore trusts) to non-resident investors.

Simultaneous with the opening of the FX-control-protected account 114, the international correspondent bank 112 signs a notice and acknowledgement agreement which binds the correspondent bank 112 into depositing all future foreign currency (i.e., a currency other than that of the emerging market country) receipts, typically those generated by the Society for Worldwide Interbank Financial Telecommunications (“S.W.I.F.T.”) network (an internationally standardized high-speed telecommunications network for sending and receiving financial messages) and classified as MT-100 transfers, which are electronic messages under the so-called MT100 standard and which are sent to an emerging market bank by a foreign bank instructing the former to on-credit an account of a customer who resides in the emerging market country. The international correspondent bank 112 can readily identify the underlying transactions so that it can automatically post these amounts to the appropriate accounts of customers.

The present invention in one or more embodiments is a passive, non-invasive system for the emerging market banks, such as bank 104 in FIG. 2. It works without interfering with the banks' normal activities in the foreign exchange market, their business processes (i.e. treasury management and operations) or established customer and correspondent banking relationships. The banks that participate will not be required to close their nostro accounts, such as account 106, or to consolidate their funds in a master account as in traditional financial securitizations. Passive involvement from the emerging market banks, and non-disturbance of their business are accomplished by establishing a technologically enabled legal structure between the emerging market banks and the rest of the world.

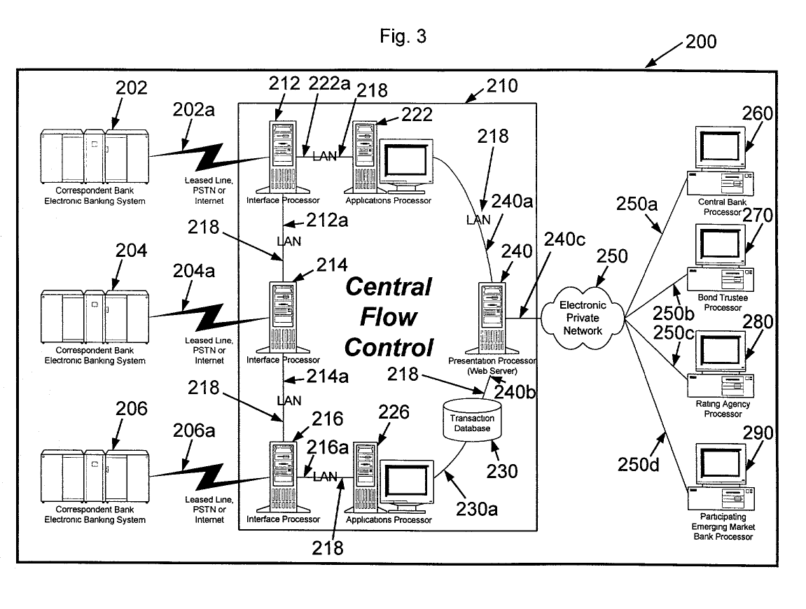

FIG. 3 shows a diagram of a detailed embodiment of a banking system 200 in accordance with a second embodiment of the present invention. The banking system 200 includes correspondent bank electronic banking systems 202, 204, and 206, interface processors 212, 214, and 216, applications processors 222 and 226, transaction database 230, presentation processor 240, electronic private network 250, central bank 260, bond trustee 270, rating agency 280 and participating emerging market bank 290.

Each of the correspondent bank electronic banking systems 202, 204, 206 may be part of an international correspondent bank, such as bank 112 of FIG. 2. Each of the correspondent bank electronic banking systems 202, 204, and 206 may be electronically connected via the leased line, publicly switched telephone network (“PSTN”) or Internet communication links 202a, 204a, and 206a respectively, or by any other communication links such as wireless links to interface processors 212, 214, and 216 respectively. Each of correspondent bank electronic banking systems 202, 204, and 206 may include one or more computers or computer processors. Each of the correspondent bank electronic banking systems 202, 204, and 206 may be part of a different correspondent bank such as for example: Citibank (TRADEMARKED) (202), PNC Bank (TRADEMARKED) (204), and the Bank of New York (TRADEMARKED) (206). Each of interface processors 212, 214, and 216, each of the applications processors 222 and 226, and the presentation processor 240 may also include one or more computers or computer processors. The transaction database 230 may include computer memory.

The interface processor 212 may be electronically connected to interface processor 214 via communication link 212a. The interface processor 214 may be electronically connected to interface processor 216 via communication link 214a. The communication links 212a and 214a may be part of a local area network (LAN) 218. The interface processor 212 may be electronically connected to applications processor 222 via communication link 222a. The interface processor 216 may be electronically connected to applications processor 226 via communications link 216a. The communication links 222a and 216a may be part of the local area network 218.

The applications processor 222 may be electronically connected to the presentation processor or web server 240 via communications link 240a. The applications processor 226 may be electronically connected to the transaction database 230 by communication link 230a, and the transaction database 230 may be electronically connected to the presentation processor 240 by communication link 240b. The communication links 230a, 240a, and 240b may be part of the local area network 218.

The presentation server 240 may be electronically connected via a communication link 240c to a private electronic communication network, such as General Electric (TRADEMARKED) private network 250. The communication network 250 may include one or any combination of communication links such as hardwired, wireless, optical, or any other. The network 250 may be electronically connected to a central bank processor 260 via a communication link 250a, to a bond trustee processor 270 via a communication link 250b, to a rating agency processor via a communication link 250c, and to a participating bank processor 290 via a communication link 250d. Each of the processors 260, 270, 280, and 290 may each actually contain one or more computer processors, or one or more other type of electronic, optical, or other known processors.

Components such as the interface processors 212, 214, and 216, the applications processor 222 and 226, the transaction database 230, and the presentation processor 240, and the communication links which link these components together are part of a central flow control apparatus or system 210 as shown in FIG. 3.

The central flow control apparatus or system 210 can be thought of as being implemented in three layers. The lowest layer, is called the “interface layer”, and may be comprised of or can be implemented in, for example, computer software programmed in interface processors, such as the interface processors 212, 214, and 216 shown in FIG. 3.

The interface layer automates cash movement functions between accounts existing within a single correspondent bank electronic banking system, such as single correspondent bank electronic banking system 202 (which may be part of Citibank (TRADEMARKED), for example). The account within a single correspondent bank electronic banking system, such as system 202, may include a FX-control-protected account, like account 114, a regular nostro account, like account 106, and, as will be explained later, a “lockbox” account, like account 118, with the particular correspondent bank (such as Citibank in this example) established for the benefit of investors. Once this Interface Layer has been built or programmed into the interface processor 212 for banking system 202, it can handle all the participating emerging market banks (such as emerging market bank 104) that have nostro accounts with any given correspondent bank or electronic banking system of a correspondent bank (such as banking system 202 of Citibank).

The next layer, can be called an “applications layer”, and this layer is responsible for aggregating the balances and flows for each participating emerging market bank, such as bank 104, and its correspondent international banks (such as international bank 112). The applications layer may be comprised of or can be implemented by computer software programmed into applications processor 222 and 226. The applications layer will make the funds transfer decisions that will be applied to each account depending on the rules specified in a FX purchase agreement, which is an agreement between the offshore trust and the emerging market central bank where the latter obtains hard currency from the former.

Finally, the last layer will be a “presentation layer”, which will be responsible for delivering reports and interacting with the various constituencies of the securitization program, which include participating emerging market banks (such as bank 104), an emerging market central bank, a bond trustee and rating agencies, which monitor the emerging market country's credit standing for investors. The presentation layer may be comprised of or can be implemented by computer software programmed into presentation processor 240.

A general overview of the interface layer, the applications layer, and the presentation layer is as follows.

(1) The Interface Layer:

Interfaces with an electronic banking system of an international correspondent bank such as system 202 in FIG. 3 and provides programmable interface object (such as those available in Java, a programming language) to the application and presentation layer.

Log-in to international correspondent bank system, such as system 202 using that bank's security protocol

Links various accounts within a given international correspondent bank, such as within system 202.

Initiate Wire Transfer Money Request (Lockbox account, such as account 118 to Bond Fiscal Agent, which may be an account outside the correspondent bank such as 112)

(2) Application Layer:

Store all activity accessing accounts in a relational database, such as database 230 in FIG. 3.

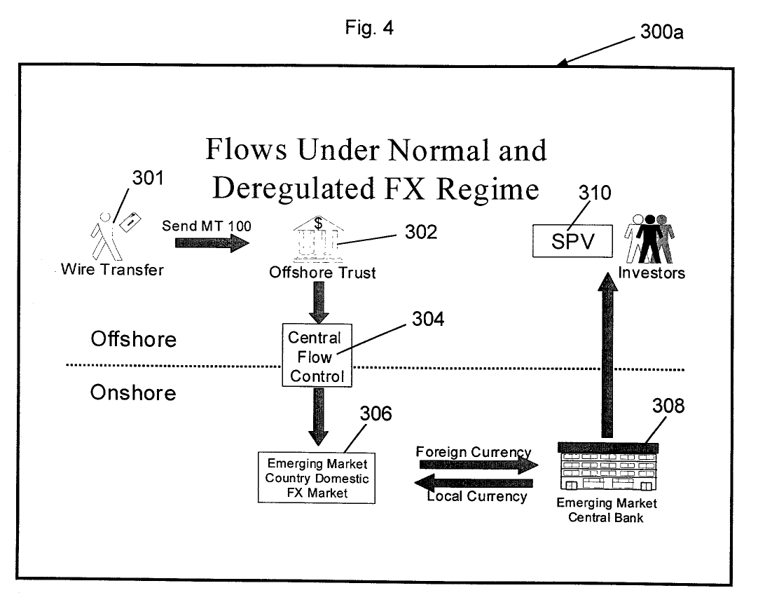

Route funds available in FX-control-protected accounts, such as account 114 according to decision criteria specified in the foreign exchange purchase agreement between the emerging market central bank, such as bank 308 in FIG. 4 and offshore trusts such as trust that owns FX-control-protected account 114 at international correspondent bank 112 in FIG. 2.

Flag down all exceptions that need operator intervention

(3) Presentation Layer:

Report aggregate activity applicable to any given participating emerging market bank such as bank 104

Report aggregate monthly cash flow coverage statistics to the emerging market central bank such as bank 308 having a processor 260 and the rating agencies at, for example, processor 280 in FIG. 3.

Report daily and monthly status of collections for investors to for, example, bond trustee processor 270.

The interface layer will typically support at least three major functions. The implementation of these three major functions should be customized for each international correspondent bank (such as bank 112) as different international correspondent banks use different methods for customers such as bank 104 in FIG. 2 to electronically access their accounts. The three major functions to be supported by the interface layer through computer software programmed into one or more interface processors, such as interface processors 212, 214, and 216 of FIG. 3, are:

(1) Ability to respond to balance information queries (concerning at least a nostro account, like account 106 in FIG. 2 and a FX-control-protected account, like account 114 in FIG. 2),

(2) Ability to respond to account activity queries (again concerning at least a nostro account and a FX-control-protected account), and

(3) Ability to transfer money from the FX-control-protected account to other accounts on a real-time basis (again concerning at least a nostro account and a moratorium proof account).

Initially, the major international correspondent banks, such as bank 112, which handle the bulk of the foreign currency (i.e. not the emerging market country's currency, U.S. dollars would be an example of a foreign currency) cash flows of the emerging market country, will be supported by the central flow control apparatus 210 shown in FIG. 3. The number of correspondent bank electronic banking systems can be increased from three (202, 204, and 206) shown in FIG. 3, to any number. Similarly the interface processors can be increased from three to any number, the applications processors 222 and 226 can be increased from two (222 and 226) to any number. Eventually, the central flow control apparatus or system 210 may have a sufficient number of interface processors, application processors, presentation processors and other components to expand coverage to all of the international correspondent banks in the world with material standing in the international correspondent banking industry. More than one transaction database, like database 230, or more than one presentation processor 240 may also be used, or database 230 itself may be comprised of more than one database and presentation processor 240 itself may be comprised of more than one processor.

Several functions may be supported by central flow control apparatus 210 at the higher level, called the applications layer, which may be implemented in for example, applications processors 222 and 226 in FIG. 3. These functions may be implemented by accessing programmable objects provided by the interface Layer, which manage the FX-control-protected accounts at the various international correspondent banks. The functions that may be supported at the applications layer, through for example applications processors 222 and 226 are:

(1) Aggregation of the deposit activity of all the FX-control-protected accounts directly owned by the respective offshore trusts established for the emerging market banks (such as bank 104, which may have a participating emerging market bank processor 290 in FIG. 3) that use the central flow control apparatus or system 210 of FIG. 3.

(2) Aggregation of the available balances of all the FX-control-protected accounts directly owned by the respective offshore trusts established for the emerging market banks (such as bank 104) that use the central flow control apparatus 210 of FIG. 3.

(3) Ascertainment of whether scheduled payments have been made by the originator (emerging market central bank, the central bank processor 260 may be part of the emerging market central bank) of the financial securitization.

(4) Distribution of funds from the various FX-control-protected accounts (such as account 114) to either the regular nostro account (such as account 106) or the investors' lockbox account (such as account 118), depending on whether the originator or emerging market central bank or central bank processor 260 has made scheduled payments into the particular international correspondent bank electronic banking system, such as for example system 202, (or via non electronic means into the corresponding international correspondent bank) and according to an allocation formula to be specified by contract between the originator (for example, emerging market central bank having central bank processor 260) and the participating emerging market banks (for example, emerging market bank 104 having participating bank processor 290)

(5) Electronic reporting functions of the above activities to the participating emerging market banks (for example emerging market bank 104 having participating bank processor 290) and to the rating agencies (for example, rating agency processor 280 in FIG. 3).

(6) User identity and validation systems using a public-key-infrastructure certification standard to be agreed upon by the emerging market central bank, and the participating emerging market banks, which will support various levels of authorization to access the central flow control apparatus or system 210.

Most of the international correspondent banks, such as bank 112 having electronic banking system 202, already provide back-office implementation of the functionalities required by the Interface layer of the system 210. The goal of the international correspondent banks in doing so is to make cash management more convenient and efficient for its customers. Two modes of remote access, for accessing an electronic banking system such as system 202, are usually supported by most of the international correspondent banks: asynchronous dial-up access and internet access. Dial-up access, which usually has the larger base of corporate and institutional users, is usually more reliable and secure than Internet access. Dial-up access also tends to be a more mature and fully tested system as many international correspondent banks have been providing direct dial-up access to their customers for over twenty years. Dial-up access is usually run by a client computer software application that is distributed by the particular international correspondent bank to its customers (often on floppy disk or CD-ROM media) and installed by customers on their desktop Personal Computers.

The more recently introduced Internet access for electronic banking is accessed by customers using web browsers most often running the secure sockets layer protocol commonly used to protect the security of the session information between the international correspondent bank and its customer.

A third mode of electronic banking capability provided by most of the major international correspondent banks are interface tools that support computer software application-to-application interaction between the electronic banking system, such as system 202 in FIG. 3, and enterprise software, such as SAP (TRADEMARKED) or ORACLE (TRADEMARKED) computer software, which is running on the customer side. In this case, the interface tools are already standardized for access by another computer software application making it easier to integrate the electronic banking functions of that international correspondent bank with the central flow control apparatus or system 210. Typically, an international correspondent bank using the third mode of electronic banking capability would only need an adapter (whether SAP (TRADEMARKED), Oracle (TRADEMARKED) or some other standard) to communicate between the central flow control apparatus 210 and the electronic banking host computer software which typically runs on a mainframe computer.

Regardless of the electronic access method provided, there is an appropriate approach for integrating the central flow control apparatus or system 210 with the target international correspondent bank's electronic banking system, such as system 202 as shown by Table 1 which follows:

TABLE 1

| Type of Access | |
|---|---|
| Scenarios | Interface Approach Utilized |
| International | Install an adapter computer software program on the interface |
| Correspondent-Bank | processor, such as interface processor 212 compatible with |
| system 202 Supplies | the particular enterprise software to manipulate the messages |
| Interface Tools for | between the Central Flow Control apparatus 210 and the |
| Enterprise Software | electronic banking system 202 |
| Client Application | Automate the user interaction required by the client |
| Running on international | application to programmatically generate the appropriate |
| Correspondent Bank | keyboard entries and mouse clicks. The automation will |
| system 202 Provided | robotically (using programmed code and logic) navigate and |
| PC Software | input information required by the host computer (being |
| | accessed by the client application) to identify and interact with |
| | the client application, such as user ID information, bank |
| | account numbers to access and selection of the desired |
| | activity from a menu of options presented and provided for by |
| | the client application. Capture and parse the client |
| | applications' information output for use by the Applications |
| | Layer. |
| International | Automate the user interaction required by the correspondent |
| correspondent bank | bank's web page to programmatically generate keyboard |
| electronic banking | entries and mouse clicks. The automation will robotically |
| system 202 uses Web | (using programmed code and logic) navigate and input |
| Browser Electronic | information required by the host computer (being accessed by |
| Banking | the web application such as a web browser) to identify and |
| | interact with the web page, such as user ID information, bank |
| | account numbers to access and selection of the desired |
| | activity from a menu of options presented and provided for by |
| | the client application. Another approach would be to reverse |
| | engineer the correspondent bank's HTML programming so |
| | that the messages expected by the correspondent bank's |
| | server can be programmatically generated by the Interface |
| | Layer. Capture and parse the information output contained in |
| | the web pages generated by the correspondent bank for use |
| | by the Applications Layer. |

Whichever approach is selected to integrate each correspondent bank's electronic banking capabilities, the interface layer, for example interface processor 212, will need to hide the complexity from the applications layer, for example processor 222 by providing a standard programmable interface—called an interface object—linking the inter-communication between all the correspondent banks such as correspondent bank 202 and the applications processor, for example applications processor 222. These programmable objects, which will have a standard set of commands and responses, will be the tools used by the programmers working on the applications layer. The minimum set of inputs for the interface object should include a code referring to the international correspondent bank such as bank 112 having banking system 202, a code for the participating emerging market bank, such as bank 104 having participating bank processor 290 and its FX-control-protected account number. The interface object should then encapsulate a link to all the attributes of this FX-control-protected account. These attributes include the regular nostro account, such as account 106 of FIG. 2 and investor lockbox account, such as account 118, to which the controlled FX-control-protected account, such as account 114, is associated with. The major functionalities that will be required of the interface-object class, which may be implemented in any object-oriented software programming language such as the Java computer software programming language, are as follows:

TABLE 2
Public Members of the Interface-Object Class

| Member Name | Type | Pupose |
|---|---|---|
| CorBankCode | Property | Code for the international correspondent bank, such as |
| | | bank 112 having system 202 to access |
| CorBankName | Property | Name of the international correspondent bank which has |
| | | been accessed (read only) |
| LocalBankCode | Property | Code for the participating emerging market bank, such as |
| | | bank 104, having processor 290 which is the beneficiary of |
| | | the offshore trust |
| LocalBankName | Property | Name of the participating emerging market bank, such as |
| | | bank 104 having processor 290 which has been accessed |
| | | (read only) |
| MPAcctNumber | Property | Account number of the Offshore Trust (the FX-control- |
| | | protected Account, such as account 114) at the |
| | | international correspondent bank, such as bank 112 having |
| | | system 202, being accessed |
| NostroAcctNumber | Property | Account number of the regular nostro account, such as |
| | | account 114, for the participating emerging market bank, |
| | | such as bank 104, having processor 290 which is linked to |
| | | the FX-control-protected account, such as account 114. |
| | | Money transfers are debited to this account. (read only) |
| BalanceQuery | Method | Asks for the current balance of the FX-control-protected |
| | | Account. Returns deposit balance, available balance, |
| | | currency code and system time of inquiry. |
| ActivityQuery | Method | Arguments are starting date and ending date for the activity |
| | | (deposits and withdrawals) involving the FX-control- |
| | | protected Account. A data array is returned with, at least, |
| | | the following information: date, amount (positive for debits |
| | | and negative for credits), transaction number, and |
| | | description of debit or credit item. |
| TransferToLocalBank | Method | Argument is the amount to be transferred from the FX- |
| | | Control-Protected Account to the linked nostro account of |
| | | the participating bank. A code indicating whether the |
| | | transfer was successful or not is returned. |
| TransferToLockBox | Method | Argument is the amount to be transferred from the FX- |
| | | Control-Protected Account to the lock box account, such as |
| | | account 118, for the investors. A code indicating whether |
| | | the transfer was successful or not is returned. |
| ConnectSuccessful | Event | Fired off when the Object has successfully logged into the |
| | | system, such as system 202, for the specific international |
| | | correspondent bank |
| ConnectFailed | Event | Fired off when the Object cannot connect to the |
| | | international correspondent bank. Argument is a code |
| | | indicating reason why connection attempt failed. |
| ConnectTerminate | Event | Fired off when a successful connection has been |
| | | terminated. Argument is a code indicating reason why |
| | | connection was terminated. |

The “Event” members of the interface object, shown in table 2, are needed to control the management of many independent jobs running concurrently on the interface processors, such as interface processors 212, 214, and 216 of the interface layer. The speed of execution of the interface processor, such as processor 212 will mostly depend on the responsiveness of the correspondent bank's electronic banking system to which it communicates, such as system 202, a factor which is beyond the control of the central flow control apparatus 210.

Design-wise, the interface objects can be implemented on an interface processor, such as interface processor 212, as individual computer software applications running on a dedicated computer processor and linked to the outside world through a leased line, the publicly switched telephone network (“PSTN”) or the Internet (a link such as 202a), depending on the access medium required by the particular system, such as system 202 of FIG. 3, of the particular international correspondent bank. The computer software programs comprising the applications layer will typically be running on separate dedicated computers, as applications processors 222 and 226 that are locally networked with the interface processors running the interface layer, such as interface processors 212, 214, and 216. Thus the present invention envisions that the central flow control apparatus 210 will really be a cluster of computers, processors or computer processors working together—some running interface layer type jobs and others running applications layer type jobs, and a few running the presentation layer type jobs. These clusters of computers can then be replicated in several data centers around the world, so that a plurality of central flow control apparatus, like apparatus 210 may be provided in the system 200 of FIG. 3, to provide redundancy and reliability for the banking system 200.

The previous discussion focused on the bank accounts that are directly and indirectly owned by the participating emerging market banks in the securitization program. All the participating emerging market banks, such as bank 104 having processor 290 shown in FIG. 3, are actually on one side of the transaction. The other side of the transaction is the emerging market central bank, having a processor 260, shown in FIG. 3. An important part of the structure of the present invention is a master FX purchase agreement whereby the participating emerging market banks, such as bank 104 having processor 290, acting collectively through their offshore trusts, agree to sell foreign currency to the emerging market central bank, such as the central bank having processor 260 and receive local currency as compensation. The emerging market central bank has the flip side of this FX purchase transaction. It receives foreign currency (foreign to the emerging market country, for example, United States dollars) and pays local (emerging market country) currency to the participating emerging market banks. At closing of the securitization, the foreign currency, which is to be received by the emerging market central bank, is assigned to a special purpose vehicle (such as 310 in FIG. 4) that will issue debt securities to the investors.

An important aspect of the transaction involves the question of where the foreign currency will be obtained by the offshore trusts (which are acting collectively). The source of such foreign currency will depend on whether or not a state of FX control or other form of capital control exists which prevents foreign currency from being transferred from the emerging market country to an offshore account. During normal times when there is no such obstacle originating from such emerging market country which prevents such transfer, the offshore trusts simply delegate the emerging market central bank to buy the foreign currency promised under the FX purchase agreement from the local FX market operating within the emerging market country. Usually this is a market dominated by the participating emerging market banks themselves. Since there is no transfer restriction, the foreign currency purchased by the emerging market central bank and assigned to investors are remitted by the seller (as ordered by the buyer, the emerging market central bank) to an offshore funding account(s) set up for this purpose with one or more of the international correspondent banks covered by the system. Therefore, the central flow control apparatus 210 will need to have electronic access to this funding account(s) set up for the central bank processor, such as processor 260 of the emerging market central bank, just as it has access to the FX-control-protected accounts set up for the offshore trusts.

If there are insufficient or no funds available in the funding account, meaning that for whatever reason the emerging market central bank did not transfer (or cause to be transferred) the scheduled and promised foreign currency amount from onshore (meaning under the control of the emerging market country) sources to the offshore (meaning not under the control of the emerging market country) account, then the central flow control apparatus 210 will obtain the foreign currency due to the investor from an offshore source. Instead of the onshore market, the promised foreign currency is taken from the offshore trusts themselves by distributed electronic deductions automatically performed by the central flow control apparatus 210 against the FX-control-protected accounts managed by it, such as FX-control-protected account 114 which may be located in system 202. The central flow control apparatus 210 may manage this account 114 via the communication link 202a. The methods and calculations by which deductions will be shared among the various offshore trusts will be carefully defined in the FX purchase agreement itself, and can be enforced by central flow control apparatus 210.

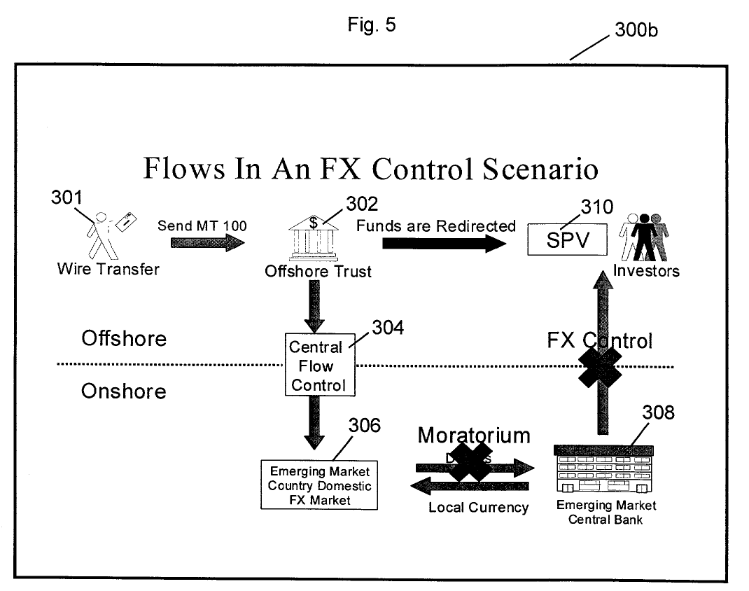

One way to describe this particular kind of FX purchase agreement, as compared to conventional FX purchase agreements in the market, is that it has a dual-source for foreign currency. The source under the swap will come from either onshore or offshore sources, depending on whether foreign currency is successfully purchased onshore and remitted offshore by the emerging market central bank having a processor, such as the emerging market central bank having processor 260. FIGS. 4 and 5 give an overview of the flow of monetary funds based on two scenarios—first, when there is no state of FX control (or capital control) which prevents transfer of funds to foreign investors (i.e. normal conditions where there is a liberalized foreign exchange market) and second, when there is such a condition occurring (or any form of FX control or capital control that prevents the same transfer to offshore investors).

In the normal and deregulated FX regime scenario shown in FIG. 4, the following occurs. A participating emerging market bank 301 (which may be the same as bank 104 having the processor 290) transfers monetary funds such as those associated with MT 100 (an electronic message standard defined by S.W.I.F.T. sent by one bank to another where the former informs the latter that funds have been credited to latter's account and that latter should credit a customer account for the same amount of the funds) into an offshore trust account 302, which may be the FX-control-protected account 114 at international correspondent bank 112. The offshore trust 302 is managed by the central flow control apparatus 304 in FIG. 4. The central flow control apparatus 306 can provide funds originating from offshore (foreign to the emerging market country) sources such as wire transfer 301 to an onshore account 306, which may be for example an account on the processor 290 of the emerging market bank 104. As an example, the onshore account 306 may provide a foreign currency, such as U.S. dollars to an emerging market central bank 308, which may be the same as the emerging market central bank having a processor 260 in FIG. 3. The foreign currency (U.S. dollars) may be provided from the onshore account 306 in exchange for local currency (in this example, Pesos, in a Philippines example, the Philippine currency) provided from the emerging market central bank 308. The emerging market central bank may then send the foreign currency (U.S. dollars in this case) to the SPV 310. The “SPV” is a special purpose vehicle organized offshore (meaning outside the control of the emerging-market country) which is a bankruptcy-remote legal entity whose sole purpose is to issue securities to offshore investors who will provide the securitization financing.

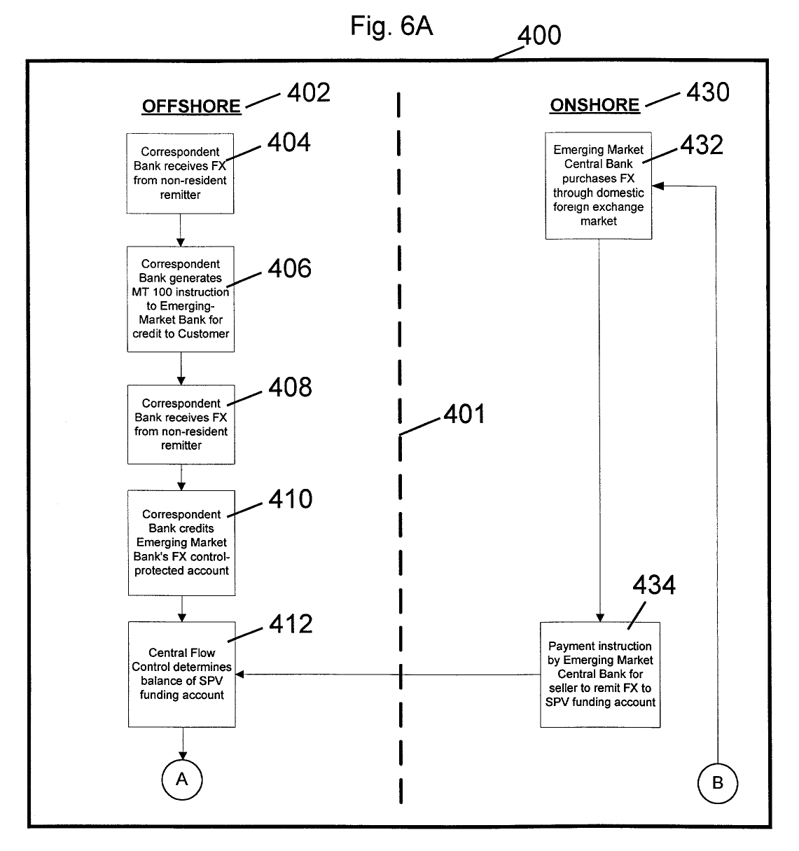

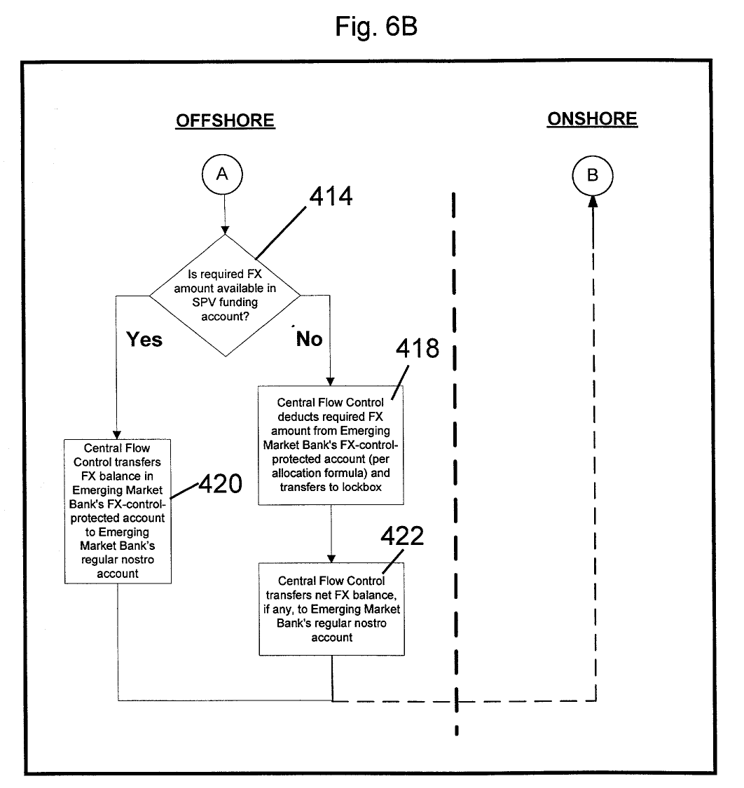

When there is a condition impeding the flow of onshore foreign currency to investors (i.e., FX control or capital control), the central flow control apparatus 210 of FIG. 3 takes over and automatically deducts funds for the SPV 310. These deductions shall be taken directly from the FX-control-protected accounts, such as account 114 of FIG. 2. Moreover, the deduction of foreign currency from the FX-control-protected account, such as account 114 of FIG. 2, does not depend on anyone having to arrive at the legal conclusion that a state of FX control or capital control preventing transfer of foreign currency out of the emerging market country has been declared by the monetary authorities or government of the emerging market country. Non-deposit of the onshore funds into the SPV funding account, as scheduled in the FX purchase agreement, will trigger the “FX control scenario” as illustrated in FIG. 5 below. FIGS. 6A and 6B show a flow chart 400 which describes the processing decisions and steps that the parties and the central flow control apparatus 210 should perform on each business day. The flow chart 400 includes steps in column 402 which typically take place off the shores of the emerging market country (meaning outside the legal jurisdiction and control of the emerging market country) and the steps in column 430 which typically take place on the shores of the emerging market country (meaning inside the legal jurisdiction and control of the emerging market country. The columns 402 and 430 are separated by dashed line 401.

At step 404 a correspondent bank receives FX (or foreign exchange) from non-resident remitters (parties who do not reside in the emerging market country). At step 406, the correspondent bank generates an MT 100 instruction (as previously defined) to the emerging market bank for credit to the customer of the emerging market bank. At step 408, the correspondent bank, such as bank 112 with system 202, receives FX (such as U.S. dollars or other hard currency) from the non-resident remitter. At step 410, the correspondent bank credits the emerging market bank's FX-control-protected account (such as account 114 for the emerging market bank 104, located at international bank 112).

The central flow apparatus 210 of FIG. 3, at step 412, determines the balance of the SPV funding account, such as the funding account of SPV 310 of FIG. 4. This SPV funding account is held in the particular correspondent bank, such as bank 112 within system 202. At step 414, the central flow apparatus 210 of FIG. 3 determines if there is a sufficient FX amount available in this funding account. The sufficient FX amount for any period during the securitization financing is determined by the documents and represents the bond coupon payments to investors plus administrative, servicing and other fees needed to support the securitization financing.

If there is a sufficient amount available, step 416 is executed wherein the central flow control apparatus 210 transfers a required FX amount from the SPV funding such as SPV 310 in FIG. 4 to a lockbox account, such as lockbox account 118, which is another account to hold FX which has been set up to support the securitization financing in every correspondent bank, such as 112 in FIG. 2, managed by the central control flow apparatus 210. The central flow control apparatus 210 transfers the FX balance in the emerging market bank's (such as bank 104 of FIG. 1 having a processor 290) FX-control-protected account (such as account 114) which is at the international correspondent bank, such as bank 112 having a system 202, to a regular nostro account (such as account 106 if FIG. 1).

If there is not a sufficient FX amount available at step 414 then step 418 is executed. At step 418, the central flow control apparatus 210 deducts the required FX amount from the emerging market bank's (bank 104) FX-control-protected account (per allocation formula as has been negotiated and defined in the securitization-related documents between the various parties involved in the financing), such as account 114 in FIG. 2, in system 202 of bank 112. At step 422 the central flow control apparatus 210 transfers net FX balance, if any to the emerging market bank's regular nostro account, such as account 106 in FIG. 2 in system 202 of bank 112. (System 202 is located offshore with respect to emerging market country, meaning that this system is outside the control and jurisdiction of the government of the emerging market country).

On the other hand, if there is sufficient FX amount available at step 414, then step 420 is executed. At step 420, the central flow control apparatus 210 transfers the FX balance in emerging market bank's (such as bank 104) FX-control-protected account (such as 114 of FIG. 2) to that same emerging market bank's regular nostro account such as 110 in FIG. 2 located in the same correspondent bank such as 112 of FIG. 2

On the shores of the emerging market country in column 430 (meaning under the legal jurisdiction of the emerging market country), at step 432 of FIG. 6A, the emerging market central bank purchases FX through the emerging market country's domestic foreign exchange market. Next at step 434 a payment instruction is issued by the emerging market central bank to the FX seller (which is any party who resides in the emerging market country and who has sold the FX to the emerging market central bank) to remit the FX purchased by the emerging market central bank to the SPV (such as 310) funding account which is located in the system 202 of the international correspondent bank 112. The method then next proceeds to step 414 and the steps, which follow as appropriate and as previously described.

The final layer of the central flow control apparatus 210, which is the presentation layer, serves up the reporting information required by the various constituencies of the financing. These constituencies are the central bank via processor 260, the bond trustee via processor 270, the rating agencies, for example via processor 280 for one rating agency, and all the participating emerging market banks, such as for example via processor 290 for emerging market participating bank 104. The presentation Layer can be implemented by computer software programmed or used on presentation processor or web server 240. The presentation layer can use web technologies such as HTML, XML and Java to dynamically present the relevant data to the constituencies on their regular desktop computer using a standard web browser. However, unlike public web applications, access to the presentation layer is restricted to the legitimate constituencies, who are permitted to connect only through a secure private network, such as network 250 which may be provided by private data networks such as that of GENERAL ELECTRIC (TRADEMARKED). Access to reports will not be available through the publicly accessible Internet. Constituents may also need to validate their identity with secure digital signatures (using public key infrastructure technology adopted by a certification authority such as VERISIGN (TRADEMARKED) to be agreed upon by the emerging market central bank and the participating emerging market banks) before they can login and authorize transactions. Authorization of transactions is only applicable for those parties linked through the central flow control apparatus 210 who are permitted to transact. Digital signatures may require a physical medium (mini CD-ROM) in the constituent's possession, as well as knowledge of a password, in order to login. The applications layer can require counter digital signatures for sensitive transactions that require several officers to authorize, such as moving money from the SPV funding account to the fiscal agent's master account for distribution to the securitization investors or from the various lockbox accounts at the various correspondent banks to the same fiscal agent's account. The fiscal agent is a financial institution appointed in the securitization financing, and which is responsible for directing payments to each investor in the securitization investor.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. A banking system comprising:
a first bank account directly owned by an first emerging market local bank chartered in a first emerging market country;
a second bank account which is owned by a trust entity, wherein the emerging market bank is the beneficiary of the trust entity; and
wherein the first bank account and the second bank account are bank accounts at a first international correspondent bank.

2. The banking system of claim 1 wherein
the first bank account is an on shore account which can be controlled by actions of a first emerging market government of the first emerging market country; and
the second bank account is an off shore account which can not be controlled by actions of the first emerging market government of the first emerging market country.

3. The banking system of claim 1 further comprising
a central flow control apparatus which can administer the first and second bank accounts.

4. The banking system of claim 3 further wherein
the central flow control apparatus is comprised of
a first interface processor which interfaces with an electronic banking system of the first international correspondent bank.

5. The banking system of claim 4 further comprising
a first applications processor;
wherein the first interface processor provides an interface object to the first applications processor.

6. The banking system of claim 4 further comprising
a first presentation processor;
wherein the first interface processor provides an interface object to the first presentation processor.

7. The banking system of claim 5 further wherein
the interface object is comprised of
a first code referring to the first international correspondent bank;
a second code referring to the first emerging market local bank; and
a third code referring to the second bank account.

8. The banking system of claim 6 further wherein
the interface object is comprised of
a first code referring to the first international correspondent bank;
a second code referring to the first emerging market local bank; and
a third code referring to the second bank account.

9. The banking system of claim 5 further wherein
the first applications processor stores all activities which access the first or the second bank account in a database.

10. The banking system of claim 5 further wherein
the first applications processor routes funds available in the second bank account according to a decision criteria specified in an FX purchase agreement between an emerging market central bank and the first international correspondent bank.

11. The banking system of claim 6 further wherein
the first presentation processor reports aggregate activity for the first and second bank accounts.

12. The banking system of claim 6 further wherein
the first presentation processor reports aggregate monthly cash flow coverage statistics concerning the first and second bank accounts to a central bank headquartered in the emerging market country.

13. The banking system of claim 6 further wherein
the first presentation processor reports aggregate monthly cash flow coverage statistics concerning the first and second bank accounts to a rating agency.

14. The banking system of claim 6 further wherein
the first presentation processor reports daily and monthly status of collections of the first emerging market bank to a trustee.

15. A method comprising the steps of
setting up a first bank account directly owned by a first emerging market local bank headquartered in a first emerging market country;
setting up a second bank account which is owned by a trust, wherein the first emerging market bank is the beneficiary of the trust; and
wherein the first bank account and the second bank account are bank accounts of a first international correspondent bank.

16. The method of claim 15 wherein
the first bank account is an on shore account which can be controlled by actions of a first emerging market government of the first emerging market country; and
the second bank account is an off shore account which can not be controlled by actions of the first emerging market government of the first emerging market country.

17. The method of claim 15 further comprising
administering the first and second bank accounts through a central flow control apparatus.

18. The method of claim 17 wherein
the central flow control apparatus is comprised of
a first interface processor which interfaces with an electronic banking system of the first international correspondent bank.

19. The method of claim 18 further comprising
a first applications processor;
wherein the first interface processor provides an interface object to the first applications processor.

20. The method of claim 18 further comprising
a first presentation processor;
wherein the first interface processor provides an interface object to the first presentation processor.

21. The method of claim 19 further wherein
the interface object is comprised of
a first code referring to the first international correspondent bank;
a second code referring to the first emerging market local bank; and
a third code referring to the second bank account.

22. The method of claim 20 further wherein
the interface object is comprised of
a first code referring to the first international correspondent bank;
a second code referring to the first emerging market local bank; and
a third code referring to the second bank account.

23. The method of claim 19 further wherein
the first applications processor stores all activities which access the first or the second bank account in a database.

24. The method of claim 19 further wherein
the first applications processor routes funds available in the second bank account according to a decision criteria specified in a FX purchase agreement between an emerging market central bank and the first international correspondent bank.

25. The method of claim 20 further wherein
the first presentation processor reports aggregate activity for the first and second bank accounts.

26. The method of claim 20 further wherein
the first presentation processor reports aggregate monthly cash flow coverage statistics concerning the first and second bank accounts to a central bank of the emerging market country.

27. The method of claim 20 further wherein
the first presentation processor reports aggregate monthly cash flow coverage statistics concerning the first and second bank accounts to a rating agency.

28. The method of claim 20 further wherein
the first presentation processor reports daily and monthly status of collections of the first emerging market local bank to a trustee.
